(19) United States
(12) Patent Application Publication
(10) Pub. No.: US 2009/0131022 A1
(43) Pub. Date: May 21, 2009

(54) Apparatuses and Methods for Anonymous Messaging

(75) Inventors: Adrian Buckley, Tracy, CA (US); Andrew Allen, Mundelein, IL (US)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(73) Assignee: Research In Motion Limited, Waterloo (CA)

(21) Appl. No.: 12/192,786

(22) Filed: Aug. 15, 2008

Related U.S. Application Data
(60) Provisional application No. 60/956,159, filed on Aug. 16, 2007.

(51) Int. Cl. H04L 12/58; H04W 4/00

(52) U.S. Cl. 455/412.1; 455/466

(57) ABSTRACT

Apparatuses and methods for facilitating anonymous messaging via a wireless network, directed to protection of information relating to a sender node. According to the disclosed apparatuses and methods, a node sending a message to one or more recipient nodes is provided with the option to conceal its identity, or at least a portion of its addressing information, from at least one recipient of the message. In order to provide compliance with applicable protocols, the sender may be assigned a temporary identifier for the purpose of transmitting the message to the recipient.

### CROSS-REFERENCE TO RELATED APPLICATIONS

This application claims priority to U.S. Provisional Application Ser. No. 60/956,159 filed Aug. 16, 2007, which is hereby incorporated by reference.

### TECHNICAL FIELD OF THE DISCLOSURE

The present disclosure relates generally to interworking between nodes in a network, and in particular to apparatuses and methods of providing anonymous communication between a first node and a second node.

### BRIEF DESCRIPTION OF THE DRAWINGS

A more complete understanding of the embodiments of the present patent disclosure may be had by reference to the following Detailed Description when taken in conjunction with the accompanying drawings wherein:

FIG. 1 is a message flow diagram showing message interworking within a wireless network;

FIG. 2 is a simplified diagram showing an interworking function disposed between two nodes in a network;

FIG. 3 is a table showing a list of session initiation protocol (“SIP”) uniform resource identifiers (“URIs”) for a user, along with corresponding telephone network (“Tel.”) URIs;

FIG. 4 is table of Short Message System (“SMS”) subscriber parameters;

FIG. 5 is a message flow diagram showing a message flow between a pair of user equipment (“UE”) devices;

FIG. 6 is a flowchart showing one embodiment of a process for assigning temporary routing numbers to interworked messages;

FIG. 7 is a flowchart showing an embodiment of a process for reconciling temporary routing numbers to permanent sender identifiers;

FIG. 8 is a message flow diagram showing an embodiment of a message flow between a service center (“SC”) and a UE device receiving a reply to an anonymized message;

FIG. 9 is a table of SMS Message Parameters;

FIG. 10 is a message flow diagram depicting an embodiment of a message flow between a UE device and a message interworking application server;

FIG. 11 is a block diagram showing an embodiment of a message interworking application server; and

FIG. 12 is a block diagram showing an embodiment of a user equipment device.

### DETAILED DESCRIPTION OF THE DRAWINGS

The present disclosure relates to methods and apparatuses for facilitating anonymous messaging via a wireless network when a form of interworking between two or more messaging systems occurs such as but not limited to Short Message Service, OMA SIMPLE etc. The methods and apparatuses set forth in the present disclosure are directed to protection of information relating to the sender node. The term “sender node” can relate to either a server or function in a network or customer premises equipment such as but not limited to a wireless device or fixed terminal. According to the methods and apparatuses, a node sending a message to one or more recipient nodes is provided with the option to conceal its identity, or at least a portion of its addressing information, from at least one recipient of the message. The term “recipient node” can relate to either a server or function in a network or customer premises equipment such as but not limited to a wireless device or fixed terminal. In order to provide compliance with applicable protocols, the sender may be assigned a temporary identifier for the purpose of transmitting the message to the recipient.

According to a first aspect of the present disclosure, the disclosed subject matter relates to a method for sending an anonymous message from a first node to a second node. The method comprises receiving from the first node a message containing privacy configuration data for messaging; receiving from the first node a first message addressed to the second node; determining whether the first message is to be sent to the second node anonymously; and retrieving from a database a temporary identifier and generating a second message to the second node comprising at least a portion of the first message and having a sender identifier matching the temporary identifier if the first message is to be sent to the second node anonymously.

According to a second aspect, the present disclosure relates to an application server configured to send an anonymous message from a first node to a second node. The server comprises a component configured to receive from the first node a request to conceal the identity of the first node; a component configured to receive from the first node a first message addressed to the second node; a component configured to determine whether the first message is to be sent to the second node anonymously; and a component configured to retrieve from a database a temporary identifier and generate a second message to the second node comprising at least a portion of the first message and having a sender identifier matching the temporary identifier if the first message is to be sent to the second node anonymously.

According to a third aspect, the present disclosure relates to a wireless device or user equipment operable to remotely configure an application server (network node) for anonymous messaging. The wireless device comprises a component configured to receive from a user privacy configuration data for messages from the user equipment device to external nodes; a component configured to store the privacy configuration data for messages; and a component configured to transmit to the application server a message containing the privacy configuration data for messages, wherein the configuration data is operable to instruct the remote message interworking application server to remove at least one identifier for the user equipment device from at least one outgoing message.

Apparatuses and systems of the present patent disclosure will now be described with reference to various examples of how the embodiments can best be made and used. Similar reference numerals may be used throughout the description and several views of the drawings to indicate similar or corresponding parts. The various elements set forth in the drawing figures are not necessarily drawn to scale.

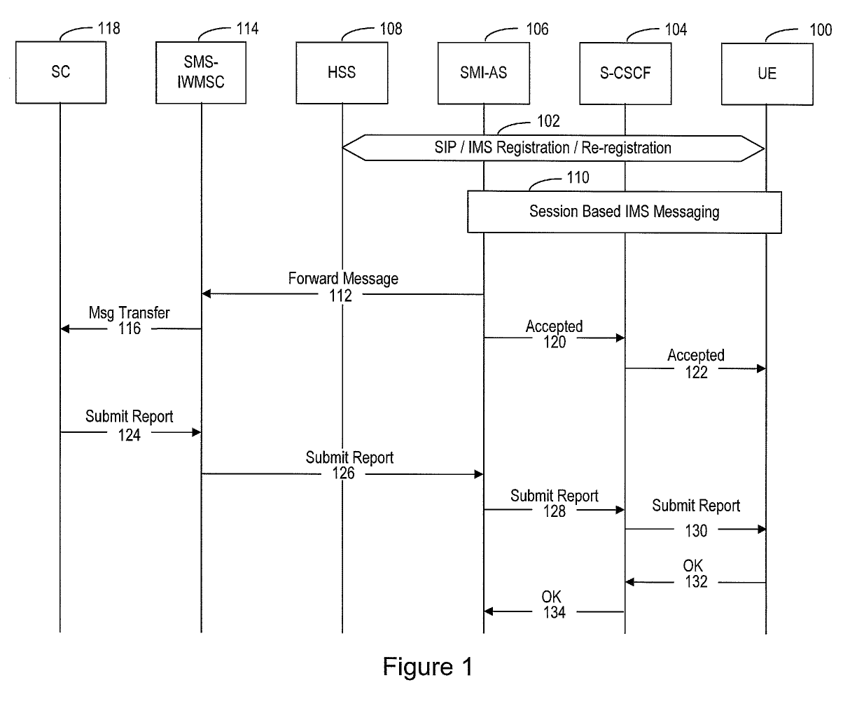

FIG. 1 depicts a message flow diagram showing one embodiment of an example message flow between a wireless device/user equipment (“UE”) device 100 and a service center (“SC”) 118 during the course of transmittal of a message. The term “user equipment,” (“UE”) can refer to a wide variety of mobile devices such as mobile telephones, personal digital assistants, handheld or laptop computers, and similar devices that have telecommunications capabilities. Such a UE might consist of a wireless device and its associated Universal Integrated Circuit Card (“UICC”) that includes a Subscriber Identity Module (“SIM”) application, a Universal Subscriber Identity Module (“USIM”) application, or a Removable User Identity Module (“R-UIM”) application or might consist of the device itself without such a card. The term “UE” may also refer to devices that have similar capabilities but that are not transportable, such as fixed line telephones, desktop computers, or set-top boxes. The term “UE” can also refer to any hardware or software component that can terminate a SIP session.

As shown in FIG. 1, message flow begins with a SIP/IMS registration or re-registration process 102 involving UE device 100, Serving Call Session Control Function (“S-CSCF”) unit 104, Short Message Interworking Application Server (“SMI-AS”) 106 and Home Subscriber Server (“HSS”) 108. Upon completion of registration process 102, UE device 100, S-CSCF 104 and SMI-AS 106 engage in session-based Internet Protocol Multimedia Subsystem (“IMS”) messaging 110. As a result of IMS messaging session 110 (within a first messaging system), a message such as, but not limited to, OMA SIMPLE is generated which is addressed to a recipient node which has no or limited capability to handle IMS messages, but has full capability to handle messages in another protocol, in this case Short Message System (“SMS”) protocol (within a second messaging system). Although IMS OMA SIMPLE and SMS are presented by way of example, the apparatuses and methods disclosed herein may be employed in connection with a variety of messaging protocols, that they are not limited to any particular messaging protocols or to any particular combinations of messaging protocols, and that the specific messaging protocols presented herein are presented only by way of example.

In general, when a first node is using a service or protocol and wishes to communicate with a second node, information as to the second node's capabilities, including information as to whether the protocols are fully compatible, may or may not be readily available to the first node. Where the capabilities of the two nodes do not match, or are unknown, there may be a need for interworking functionality. Where the services employed by the two nodes vary, the underlying transport mechanisms may also vary. Under such circumstances, an interworking network node, in this embodiment SMI-AS 106, may be configured to perform interworking functions to allow the message from the sender node to be compatible with the recipient node.

Subsequent to interworking, SMI-AS 106 forwards a message 112 to Short Message System Interworking Mobile Services Switching Center (“SMS-IWMSC”) 114, which is transferred to Service Center 118 as message 116. SMI-AS 106 sends a message 120 to S-CSCF 104 indicating that the message was accepted, which is forwarded to the UE device 100 as message 122.

After message 116 is received at SC 118, SC 118 submits a report and transmits it to SMS-IWMSC 114, as represented by message 124. SMS-IWMSC 114 then forwards report 124 to SMI-AS 106 as represented by message 126. SMI-AS 106 forwards the report to S-CSCF 104 as message 128, which is forwarded to UE device 100 as message 130. Upon receipt of message 130, UE device 100 sends an OK 132 to S-CSCF 104, which is relayed to SMI-AS 106 as message 134. As noted above, the specific IMS-to-SMS message flow described above is presented only by way of example, and there is nothing in any of the apparatuses and methods presented herein which limit their use to any specific protocols or combinations of protocols.

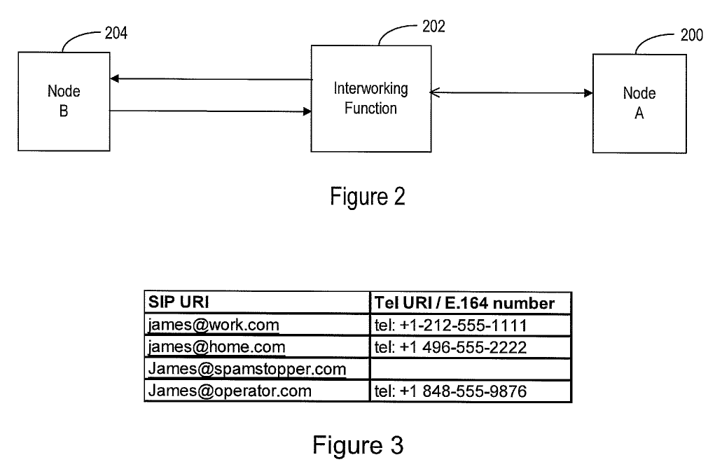

The interworking functionality referred to and described in connection with FIG. 1 is depicted in somewhat simplified and generalized form in FIG. 2, which illustrates an example message flow showing general service level interworking between a sender node 200 and a recipient node 204 employing different protocols for messaging. Sender node 200, which may be a wireless device such as UE 100 of FIG. 1, is configured to send a message according to a first messaging protocol, which may be, for example, an Open Mobile Alliance SIMPLE (“OMA SIMPLE” or “SIMPLE”) message. The message is directed to recipient node 204, which may be another wireless device or other network node which may not be fully compatible with the messaging protocol employed by sender node 200. In order to reliably deliver the message to recipient node 204 under such circumstances, the message may need to be translated into a second protocol, such as an SMS protocol, with which recipient node 204 is more compatible.

Within the context of the example above of a session or message being sent from sender node 200 to recipient node 204, an interworking process must take place between sender node 200 and recipient node 204, owing to the fact that recipient node 204 is not configured to receive a message in the message protocol sent from sender node 200. This interworking functionality is represented by interworking function 202. In effect, the service from sender node 200 to recipient node 204 may be considered terminated at interworking function 202, while another service is invoked at interworking function 202 toward recipient node 204.

Message interworking can present a number of issues in connection with message addressing, privacy and security. In particular, where interworking functionality is employed, there is a risk that a recipient node may be provided with information that was not intentionally disclosed by the sender node. Normally, a message from one node to another node identifies the sender node by some unique identifier. According to certain messaging protocols, a sender, such as sender node 200, may have the option of selecting from among a number of different public user identities by which to be known to recipient node 204. FIG. 3 is a table showing a variety of addresses and identifiers by which a hypothetical user or node may be known. In the example shown in FIG. 3, the user has four different “identities” set up within a single device. This user has a work identifier (“james@work.com”), a home identifier (“james@home.com”), a supplemental identifier (“james@operator.com”) and an additional identifier (“james@spamstopper.com”) which may be used to communicate with users who are not well known to this user. Three of these identities have a Telephone Network Uniform Resource Identifier (“Tel.URI”) associated therewith, and one (“james@spamstopper.com”) does not.

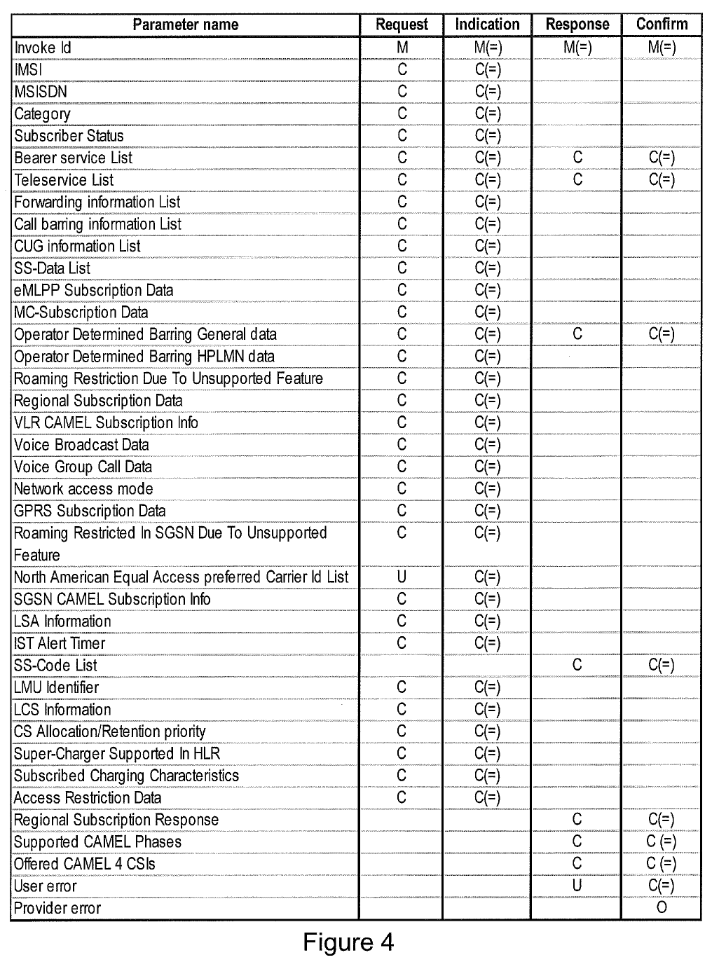

In the SMS domain, a user may be identified by a single Mobile Station International Subscriber Directory Number (“MSISDN”) and a single International Mobile Subscriber Identity (“IMSI”). FIG. 4 shows the data associated with a particular user in the SMS domain used in the MAP protocol. The characteristics of this data are further illustrated by the Abstract Syntax Notation One (“ASN.1”) code configured to insert subscriber data for an SMS subscriber, an example of which follows:

insertSubscriberData OPERATION ::= {
ARGUMENT SEQUENCE {

| | |
|---|---|
| imsi | [0] IMPLICIT OCTET STRING ( |

SIZE( 3 .. 8 ) ) OPTIONAL,

| | |
|---|---|
| msisdn | [1] IMPLICIT OCTET STRING ( |

SIZE( 1 .. 20 ) ) ( SIZE( 1 .. 9 ) ) OPTIONAL,

| | |
|---|---|
| category | [2] IMPLICIT OCTET STRING ( |

SIZE( 1 ) ) OPTIONAL,

| | |
|---|---|
| subscriberStatus | [3] IMPLICIT ENUMERATED { |

| | |
|---|---|
| serviceGranted | ( 0 ), |
| operatorDeterminedBarring | ( 1 ) } OPTIONAL, |

| | |
|---|---|
| bearerServiceList | [4] IMPLICIT SEQUENCE ( SIZE ( |

1 .. 50 ) ) OF

OCTET STRING ( SIZE( 1 .. 5 ) ) OPTIONAL,

It can be seen from FIG. 4 and the ASN.1 code above that Mobile Switching Centers (“MSCs”) and Serving GPRS Support Nodes (“SGSNs”) will receive only a single MSISDN and a single IMSI from a node sending an SMS message. Where a message sent in a first messaging protocol, such as an OMA SIMPLE message, is interworked to a second messaging protocol, such as an SMS messaging protocol, differences in addressing schemes can give rise to a number of potential issues related to privacy and security.

As noted, OMA SIMPLE messages employ a public user identity that does not incorporate a corresponding Tel.URI matching the MSISDN in the Mobile Application Part (“MAP”) insert subscriber data. If it is desirable to provide a return path for a response message to a sender node, such as sender node 200, the original recipient node 204 must receive an acceptable sender node identifier in order to return a message to the original sender node 200. For an SMS message, an acceptable sender node identifier includes a valid MSISDN. SMS-Submit does not provide the original sender node 200 with an address or identifier of the node through which the original recipient node is contacting the original sender node 200. If communication of this information to the original sender node 200 is desired, it is necessary to communicate it via another mechanism.

Even where a message sender at node 200 may be willing to disclose his or her Session Initiation Protocol Uniform Resource Identifier (“SIP-URI”) to the recipient at node 104, the sender of an OMA SIMPLE message may nevertheless prefer to not release their MSISDN to the recipient of the resulting SMS message. Because the SMS message is addressed from the sender node's MSISDN and not a SIP-URI, the MSISDN of sender node 200 may become known to the recipient node 104 against the preferences of the sender. This can occur even where privacy is invoked in connection with the original OMA SIMPLE message from sender node 200.

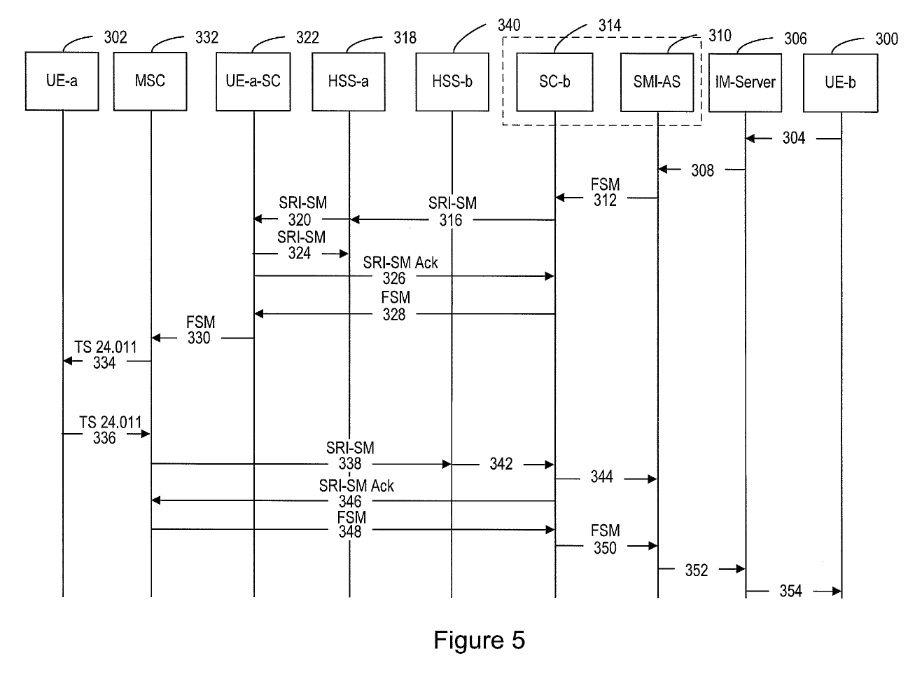

The present disclosure provides methods and systems by which the above issues may be addressed. FIG. 5 shows an overview of a message flow, according to an embodiment, between a first UE device 300 and a second UE device 302 during the course of a complete messaging procedure involving interworking. Message flow begins with transmittal of message 304 (in a first messaging protocol) from UE-b 300 to Instant Messaging (“IM”) server 306. Upon receipt of message 304 from UE-b 300, IM server 306 transmits message 308 to SMI-AS 310.

As above, the message sent by UE-b 300 and received by SMI-AS 310 conforms to a protocol with which UE-a 302 is not fully compatible. Accordingly, in order for the message to be fully utilized by UE-a 302, the message must be interworked to a compatible protocol, in this case, the SMS protocol (a second messaging protocol).

As described above, a number of issues can arise when a message in one format is interworked to a different format. One issue that can arise relates to message addressing. As further noted above, OMA SIMPLE messages (first messaging protocol) provide a sender with the capability to send messages from one of a number of “identities,” but SMS messages (second messaging protocol) recognize only a single MSISDN as a sender's identity. Thus, an OMA SIMPLE message interworked to an SMS message may disclose a sender's MSISDN to a recipient against the sender's wishes. This is only one example of a situation wherein a message sender may wish to prevent disclosure of information to a message recipient.

In order to prevent inadvertent disclosure of sender identification to a recipient, SMI-AS 310 is configured to replace one or more of the permanent sender identifiers in the original message with temporary “dummy” sender identifiers assigned for that particular message or to that sender node for some period of time. As an example, SMI-AS 310 may replace the sender node's permanent MSISDN with a temporary “dummy” MSISDN, or other numeric or alphanumeric string consisting of one or more characters or digits, assigned for the purpose of sending that particular message or for messages originating from that sender node. Where sender identifiers have been replaced, messages, senders and recipients may be tracked. All of this is described in further detail below.

Subsequent to interworking, SMI-AS 310 sends forwarded short message (“FSM”) 312 to SC-b 314. Upon receipt of FSM message 312 from SMI-AS 310, SC-b 314 sends a request 316 to HSS-a 318 to send routing information (“SRI-SM”) for the FSM 312, which is forwarded as SRI-SM request 320 to UE-a-SC 322.

Upon receipt of SRI-SM request 320, UE-a-SC 322 sends SRI-SM message 324 to HSS-a 318, and then acknowledges SRI-SM 320 to SC-b 314 via SRI-SM Ack 326. Upon receipt of SRI-SM Ack 326, SC-b 314 sends FSM 328 to UE-a-SC 322, which then forwards it to Mobile Services Switching Center (“MSC”) 332 as FSM 330. Upon receipt of FSM 330 from UE-a-SC 322, MSC 332 engages in point-to-point (“PP”) SMS communications with UE-a 302 over a radio interface, as set forth in Third Generation Partnership Project Technical Specification (“3GPP TS”) 24.011. These communications are represented by messages 334 and 336 between MSC 332 and UE-a 302.

Message 336 from UE-a 302 to MSC 332 represents an SMS message in reply from UE-a directed back to UE-b. Upon receipt of message 336, MSC 332 generates SRI-SM 338 to HSS-b 340, which is forwarded to SC-b as message 342, and then to SMI-AS 310 as message 344. Upon receipt of message 342, SC-b 314 generates an acknowledgement message 346 back to MSC 332. Upon receiving acknowledgement message 346, MSC 332 forwards the short message to SC-b 314, as represented by message 348. SC-b then forwards the short message to SMI-AS 310, as represented by message 350.

When a message is received at SMI-AS 310, the interworking function may need to determine whether the message is a response to a message for which sender privacy has been invoked. If the message is such a reply, the interworking function will then identify the identity and address information for the original sender. As an example, the interworking function may identify the true, permanent MSISDN for the original sender from the “dummy” temporary MSISDN or other string used for communication with the original recipient such as, but not limited to SIP URI, Tel URI, etc.

Once the true permanent identifier or address corresponding to the temporary “dummy” identifier is determined, the SMI-AS 310 may direct the reply message to the original sender via the original sender's true permanent identifier or address. In certain embodiments, the message will only be forwarded if the sender has indicated that response functionality is desired. If the original sender has indicated otherwise, responses from the original recipient are not forwarded to the original sender. Depending on the application and the particular configuration, the original recipient may or may not receive an indication that the reply was not delivered.

In the embodiment shown in FIG. 5, the original sender has indicated that response functionality is desired. Thus, the response message from UE-a 302 is interworked if necessary and forwarded to IM-Server 306 as message 352, and then to UE-b as message 354.

The message interworking application server may be configured such that when service level interworking is required, a particular sequence of operations occurs. According to certain embodiments, a user may be provided with the option to define a list of sender node identifiers, such as digit strings (E.164 numbers), SIP-URIs or Tel.URIs, for which privacy may and may not be imposed if privacy has not already been invoked by another configuration setting. A number of potential options arise.

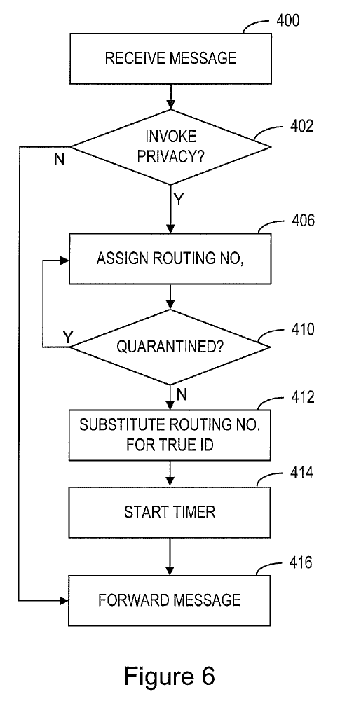

An embodiment of an interworking and privacy operation is depicted in flowchart form in FIG. 6. The interworking function may be invoked when a sender node, such as a UE, sends a message according to a first protocol, such as an OMA SIMPLE message, to a recipient node which is not fully compatible with the first protocol. Process flow begins in step 400, where the message interworking application server receives a message. As noted above, the message will generally include identifying information for the sender node. The identifying information may include a Tel URI, SIP-URI, a Globally Routable User Agent URI (“GRUU”) or another unique identifier. Upon receipt of a message, process flow proceeds to decision block 402, where a determination is made as to whether privacy should be invoked for this message.

The determination as to whether privacy settings should apply to a given message may vary from one implementation to another. The determination as to whether the message invokes privacy may be governed by user or operator policy or via analysis of the message itself. Privacy may be invoked, for example, if the “From” field in the message header is set to an anonymous identifier (e.g. “<sip:anonymous@anonymous.invalid>”), or an anonymous Globally Routable User Agent URI (GRUU) has been used. Privacy may also be invoked if a privacy tag is set.

Privacy settings may be configured to forward messages completely anonymously whenever interworking occurs in connection with communications with particular recipient identifiers, such as certain Tel URIs, SIP-URIs or MSISDNs. Alternately, complete anonymity may be imposed whenever interworking occurs with recipient nodes which are not specifically identified. Return message forwarding capability may or may not be enabled in either case.

Alternately, privacy may be configured to conceal only a portion of the sender node's identifying information whenever interworking occurs in connection with communications with particular recipient identifiers, such as certain Tel URI's, SIP-URIs or MSISDNs. Alternately, sender node identifier concealment may be imposed whenever interworking occurs with recipient nodes which are not specifically identified. Return message forwarding capability may or may not be enabled in either case.

The selected recipient identifiers for which privacy is to be invoked may be referenced to the message interworking application server in a number of ways. The identifiers may be unique public user identifiers, or may be specified using ranges or wildcards. Tel.URIs might be identified by country code, by area code or by local exchange, as examples, or using a wildcard string such as “1212555*” or “1212*5555”. SIP-URIs may be identified by domain or internet protocol address, or using a wildcard string such as “*@home.com”, with the * in these instances acting as a wildcard character reading on any character string.

Where a determination is made that privacy is to be invoked for a particular message, the message interworking application server can generate and/or choose from a pool of available numbers a temporary message interworking routing number or other string which functions as a temporary “dummy” sender identifier, and will replace the permanent sender node identifier origination address with the chosen temporary routing number, as set forth below. If privacy is not to be invoked, process flow proceeds to block 416, where the message is forwarded to the recipient in the normal manner.

If privacy is invoked, process flow proceeds to block 406, where an anonymous routing number is assigned to the sender. The anonymous routing number can be generated and/or selected from a pool of available routing numbers. The following code segment sets forth an example of how this might be implemented in a mo-ForwardSM operation:

mo-ForwardSM OPERATION ::= {
ARGUMENT SEQUENCE {

| | |
|---|---|
| sm-RP-DA | CHOICE { |

| | |
|---|---|
| imsi | [0] IMPLICIT OCTET |

STRING ( SIZE( 3 .. 8 ) ),

| | |
|---|---|
| lmsi | [1] IMPLICIT OCTET |

STRING ( SIZE( 4 ) ),

| | |
|---|---|
| serviceCentreAddressDA | [4] IMPLICIT OCTET |

STRING ( SIZE( 1 .. 20 ) ),

| | |
|---|---|
| noSM-RP-DA | [5] IMPLICIT NULL}, |

| | |
|---|---|
| sm-RP-OA | CHOICE { |

| | |
|---|---|
| msisdn | [2] IMPLICIT OCTET |

STRING ( SIZE( 1 .. 20 ) ) ( SIZE( 1 .. 9 ) ),

| | |
|---|---|
| serviceCentreAddressOA | [4] IMPLICIT OCTET |

STRING ( SIZE( 1 .. 20 ) ),

| | |
|---|---|
| noSM-RP-OA | [5] IMPLICIT NULL}, |

| | |
|---|---|
| sm-RP-UI | OCTET STRING ( SIZE( 1 .. |

200 ) ),

| | |
|---|---|
| sm-RP-OA | CHOICE { |

| | |
|---|---|
| msisdn | [2] IMPLICIT OCTET |

STRING ( SIZE( 1 .. 20 ) ) ( SIZE( 1 .. 9 ) ), = SHORT
MESSAGE INTERWORKING-AS-RN

After assignment of a routing number, process flow proceeds to block 410. In decision block 410, a check is made to ensure that the newly assigned routing number is not quarantined. If the newly assigned routing number is quarantined, process flow returns to block 406 for assignment of a new routing number. Otherwise, process flow proceeds to block 412.

In block 412, the anonymous routing number (k) is substituted for the sender's permanent identifier and process flow proceeds to block 414. Once the message interworking routing number is associated with the message and the true permanent sender identifiers, a “lifetime” timer may be started against the message interworking routing number, as well as any additional identifiers. Addition identifiers might include, for example, an assigned IMSI (f) dynamically assigned in a similar manner to that of the routing number/string, as set forth in block 414. The routing number and any additional identifiers (e.g., an assigned IMSI) are known generally as “session identifiers”. In the context of an SMS message, the TP-Validity-Period in the SMS-SUBMIT may be set to the time at which the lifetime timer associated with the routing number/string will expire. In addition, the message interworking application server may create a record linking the SIP parameters/headers FROM and CONTACT address to the message interworking routing number and any other identifiers, such as routing URIs. After setting of the timer and any other recording tasks, process flow proceeds to block 416, where the newly-addressed message is forwarded to the recipient. Thus, such a record may have a form similar to the following:

IMSI (f),_{[B1]} Routing Number (k)
R-URI=Tel URI e.g. E.164 number
FROM address
Contact Address
Time stamp routing identifiers assigned
Validity timer session identifiers are valid for

The above described message flow and process can be performed according to a number of various implementations, and may include a variety of additional steps as necessary or desirable. It may be desirable, for example, to be able to identify the origination service transaction from the IM-Server 306 to SMI-AS 310 if and when the recipient replies to the message from UE-b 300. Thus, many session identifiers may be created at SMI-AS 310. Session identifiers could include, for example, MSISDNs or E.212 numbers (IMSIs). Depending on the implementation, session identifiers might be used to identify the interworking function, to identify the session which was terminated at the interworking function, to explicitly identify UE-b 300 to UE-a 302 or to identify UE-b 300 implicitly and indirectly by concealing from UB-a 302 identification data for UE-b 300. One or more of these session identifiers may be sent to UE-a 302 in order that it may communicate back to UE-b 300. UE-b 300 may use one or more of these session identifiers when it initiates its service type to the interworking function to communicate with UE-a 302. Depending on the manner in which the underlying transport mechanism may work, one or more session identifiers may be used to retrieve additional session identifiers from SMI-AS 310 in order to reach the interworking function.

Configuration data for the message interworking routing numbers, such as SMI-AS-RNs, may include a sender node identifier start address and the quantity of routing numbers to be allocated. Configuration data may also include the prior sender node identifier start address number. To allow for flexibility in the routing number allocation plan, there may be multiple number ranges defined by the configuration data, thereby allowing multiple pools of message interworking routing numbers to be allocated from the different number ranges. Additionally, message interworking routing numbers can be generated within the different number ranges.

Configuration data for the message interworking routing number allocation plan may also include one or more “timer” values which define the “lifetime” of a routing number allocation. The lifetime of the allocation determines the time period between the association of a particular message interworking routing number with a particular sender's identifier and the release of that message interworking routing number. After the expiration of the lifetime of a routing number allocation, that message interworking routing number may be released for immediate reallocation or may be “quarantined” for some period of time before it is available for re-allocation. A message interworking routing number which is quarantined cannot be reallocated to a new sender node identifier until the expiration of the quarantine period.

As noted above, routing numbers in the SMS context will generally include MSISDNs. Routing numbers may, however, also include other identifiers, such as IMSIs, in which case a block of IMSIs will need to be reserved for use by the SMI-AS and allocation to sender nodes. An IMSI may then be chosen and reserved against the message interworking routing number. Configuration data for IMSI message interworking routing numbers (“SMI-AS-RN-IMSIs”) may include an E.212 start address number and the quantity of SMI-AS-RN-IMSIs to be allocated. Configuration data may also include the prior E.212 start address number. To allow for flexibility in the routing number allocation plan, there may be multiple number ranges defined by the configuration data, thereby allowing multiple pools of SMI-AS-RN-IMSIs to be allocated from the different number ranges.

As with the SMI-AS-RNs, configuration data for the SMI-AS-RN-IMSI allocation plan may also include one or more “timer” values which define the “lifetime” of a routing number allocation. The lifetime of the allocation determines the time period between the allocation of a particular SMI-AS-RN-IMSI and the release of that SMI-AS-RN-IMSI. After the expiration of the lifetime, the SMI-AS-RN-IMSI may be released for subsequent use or may be “quarantined” for some period of time before it is available for reallocation. An SMI-AS-RN-IMSI which is quarantined cannot be reallocated until the expiration of the quarantine period.

The above message flow and process may be implemented within a variety of contexts. Within the SMS context, if return routing has not been requested by the operator or according to user policy, the message interworking application server (in this case, the SMI-AS) may construct a MAP-Forward-Short-Message with SMS-Submit. The origination address will be set to either an MSISDN or a non-MSISDN identifier, such as a digit string. If an MSISDN is used, any reply message from the recipient will be routed back to the SMI-AS. If a non-MSISDN identifier is used, a reply message may or may not be routed back to the SMI-AS.

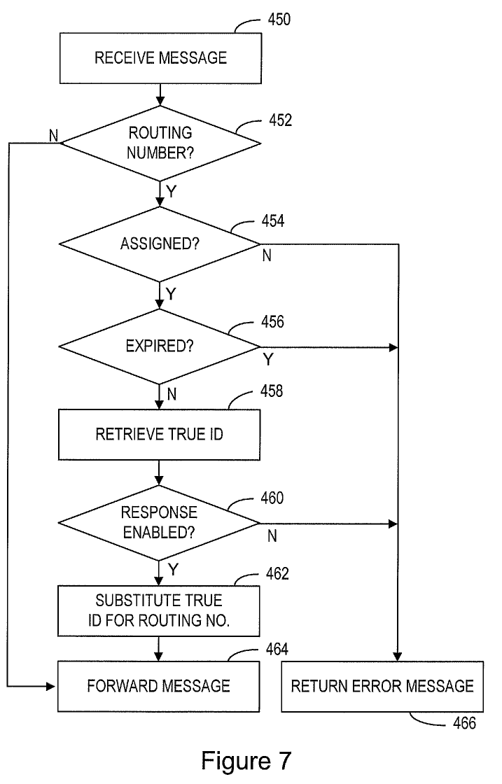

The temporary sender identifier provided to the original recipient provides a return address back to the message interworking application server. Thus, a reply to the original message will be delivered back to the message interworking application server. One embodiment of the manner in which the server will attend to the message is set out in FIG. 7.

As shown in FIG. 7, process flow begins in block 450, wherein a node, which may be the message interworking application server, receives a message or a query related to a message. Upon receipt of the message or query, a determination is made at block 452 as to whether the identifying information for the message recipient corresponds to a session identifier which has been reserved for use in anonymous messaging. If the message recipient information does not correspond to a routing number, process flow proceeds to block 464, where the message is forwarded for further processing.

If the message recipient information corresponds to a routing number reserved for anonymous messaging, process flow proceeds to block 454, where a determination is made as to whether one or more session identifier(s) referenced in the received message have been assigned to a sender. If one or more session identifier(s) have not been assigned, process flow proceeds to block 466, where an error message is returned to the message sender. In other words, if the message interworking application server receives a message or request related to one or more session identifier(s) which have no record information associated therewith in the message interworking application server, then the incoming SMS message will not be delivered.

If one or more session identifier(s) have been assigned to a sender, process flow proceeds to block 456, where a determination is made as to whether the assignment of the routing number has expired and is no longer valid. If the assignment has expired, process flow proceeds to block 466, where an error message is returned to the message sender.

If the assignment of the routing number has not expired, process flow proceeds to block 458, where the original sender identifier corresponding to the routing number is retrieved, and process flow proceeds to block 460, where a determination is made as to whether the original sender has enabled response capability. If the original sender has not enabled response capability, process flow proceeds to block 466, where an error message is returned to the message sender.

If the original sender has enabled response capability, then process flow proceeds to block 462, where the original sender's permanent true identifier is substituted for the routing number, and then to block 464, where the message is forwarded to the sender of the message to which the current message is a reply.

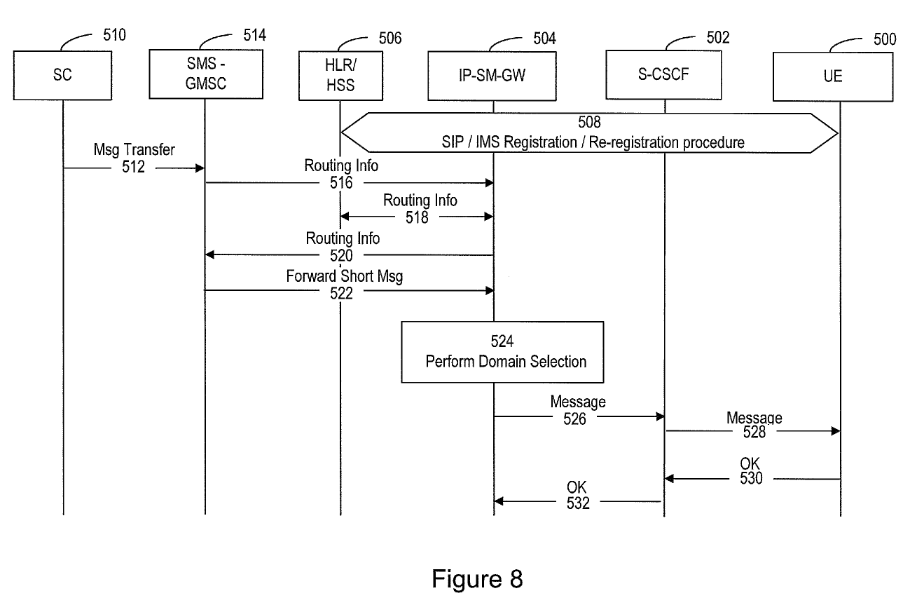

FIG. 8 is a diagram showing an embodiment wherein a message is sent to a network that supports SMS-IP interworking. As seen in FIG. 8, message flow begins with a SIP/IMS registration/re-registration procedure 508 between UE 500, S-CSCF 502, Internet Protocol Short Message Gateway (“IP-SM-GW”) 504 and HLR/HSS 506. At a point subsequent in time to the completion of registration procedure 508, SMS-GMSC 514 receives from SC 510 an incoming message directed to UE 500, as represented by message 512. When the sender node generates an SMS-SUBMIT with the temporary sender node identifier, the SMS-Gateway Mobile Switching Center (“SMS-GMSC”) generates a query to a Home Subscriber Server (“HSS”) containing this sender node identifier. Upon receipt of message 512, SMS-GMSC requests routing information for the message from IP-SM-GW 504, as represented by message 516. Upon receipt of request 516, IP-SM-GW 504 requests and receives routing information from HLR/HSS 506, as represented by message 518.

In the example shown in FIG. 8, it is assumed that the HSS will either act as a relay or map the routing number internally. If the HSS acts as a relay, it will pass the sender node identifier on to the message interworking application server, which will return an IMSI corresponding to the routing number. If the HSS is configured to map the sender node identifier internally, it may have a pre-configured routing number mapped against an IMSI, in which case the IMSI-routing number combination will match the combination chosen in the message interworking application server. In the SMS context, the message interworking application server (i.e., the SMI-AS) will then generate a SEND-ROUTING-INFO-FOR-SMS-ACK that contains the IMSI identified as corresponding to the sender node identifier. The following is a coding example showing how this may be effectuated:

sendRoutingInfoForSM OPERATION ::= {
ARGUMENT SEQUENCE {

| | |
|---|---|
| msisdn | [0] IMPLICIT OCTET STRING |

( SIZE( 1 .. 20 ) ) ( SIZE( 1 .. 9 ) ),

| | |
|---|---|
| sm-RP-PRI | [1] IMPLICIT BOOLEAN, |
| serviceCentreAddress | [2] IMPLICIT OCTET STRING |

( SIZE( 1 .. 20 ) ),

| | |
|---|---|
| extensionContainer | [6] IMPLICIT SEQUENCE { |

| | |
|---|---|
| privateExtensionList | [0] IMPLICIT SEQUENCE |

( SIZE( 1 .. 10 ) ) OF

SEQUENCE {

| | |
|---|---|
| extId | MAP-EXTENSION .&extensionId |

( {

,
...} ) ,

| | |
|---|---|
| extType | MAP-EXTENSION .&ExtensionType |

( {

,
...} { @extId } ) OPTIONAL}

OPTIONAL,

| | |
|---|---|
| pcs-Extensions | [1] IMPLICIT SEQUENCE { |

... } OPTIONAL,

... } OPTIONAL,

| | |
|---|---|
| ... , | |
| gprsSupportIndicator | [7] IMPLICIT NULL |

OPTIONAL,

| | |
|---|---|
| sm-RP-MTI | [8] IMPLICIT INTEGER ( 0 |

.. 10 ) OPTIONAL,

| | |
|---|---|
| sm-RP-SMEA | [9] IMPLICIT OCTET STRING |

( SIZE( 1 .. 12 ) ) OPTIONAL}
10 RESULT SEQUENCE {

| | |
|---|---|
| imsi | OCTET STRING ( SIZE( 3 .. |

8 ) ),

Upon receipt of a MAP-MT-FORWARD-SHORT-MESSAGE, the message interworking application server (SMI-AS) will examine the IMSI received in MT-ForwardSM, as set forth below:

mt-ForwardSM OPERATION ::= {
ARGUMENT SEQUENCE {

| | |
|---|---|
| sm-RP-DA | CHOICE { |

| | |
|---|---|
| imsi | [0] IMPLICIT OCTET |

STRING ( SIZE( 3 .. 8 ) ),

| | |
|---|---|
| lmsi | [1] IMPLICIT OCTET |

STRING ( SIZE( 4 ) ),

| | |
|---|---|
| serviceCentreAddressDA | [4] IMPLICIT OCTET |

STRING ( SIZE( 1 .. 20 ) ),

| | |
|---|---|
| noSM-RP-DA | [5] IMPLICIT NULL}, |

| | |
|---|---|
| sm-RP-OA | CHOICE { |

| | |
|---|---|
| msisdn | [2] IMPLICIT OCTET |

STRING ( SIZE( 1 .. 20 ) ) ( SIZE( 1 .. 9 ) ),

| | |
|---|---|
| serviceCentreAddressOA | [4] IMPLICIT OCTET |

STRING ( SIZE( 1 .. 20 ) ),

| | |
|---|---|
| noSM-RP-OA | [5] IMPLICIT NULL}, |

| | |
|---|---|
| sm-RP-UI | OCTET STRING ( SIZE( 1 .. |

200 ) ),

Upon receipt of message routing information from HLR/HSS 506, IP-SM-GW sends the routing information to SMS-GMSC 514, as represented by message 520. Upon receipt of the routing information from IP-SM-GW 504, SMS-GMSC 514 forwards the short message to IP-SM-GW 504, as represented by message 522. Upon receipt of the short message 522, the IP-SM-GW 504 performs domain selection, then sends the message 526 on to S-CSCF 502, which then forwards the message on to UE 500 as message 528. Upon receipt of message 528, UE 500 generates an OK 530 to 502, which is forwarded to IP-SM-GW as message 532.

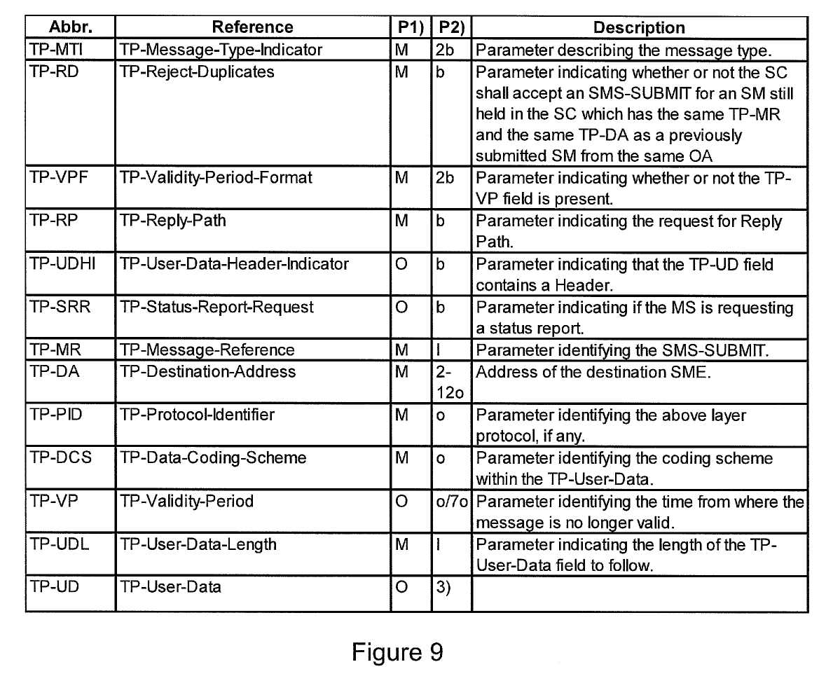

According to certain implementations when a node sends a message according to a first messaging protocol, such as an OMA SIMPLE message and some form of interworking needs to be performed, the SIP-URI may be embedded in the SMS-Submit body, in the Tp-User-data, as shown in FIG. 9. The format of the URI may be such that the user can recognize the identity of the originating node for the message and choose to either address the user using a compatible OMA SIMPLE client or embed the URI in any outgoing SMS message to the original sending party.

Under these circumstances, upon receipt of an OMA SIMPLE message, the message interworking application server may remove the “From” address if privacy has not been requested per methods identified earlier in this application. The server may then construct and send one or more SMS messages to the recipient depending on the length of the original OMA SIMPLE message received from the sender.

In certain embodiments, the UE device may be provided with the ability to control the privacy settings in the message interworking application server or in a policy server or other node in communication with the message interworking application server. Depending on the application, the UE device may use the Ut interface, Unstructured Supplementary Services Data (“USSD”) service, or similar interface to communicate with the relevant node. Privacy settings could be controlled via extensible markup language (“XML”). The UE device may be able to control whether anonymity is invoked when interworking occurs and whether concealment of the sender node identifier (e.g., MSISDN) is invoked when interworking occurs. In either case, the UE device may also be able to control whether a recipient may respond to messages having privacy invoked. A user may be willing to accept release of their SIP-URI or Tel.URI to a recipient of the original OMA SIMPLE message, but not willing to accept release of this information if interworking occurs. For any of the above options it may be possible to define one or more URIs, or a range, for which a particular setting is to apply.

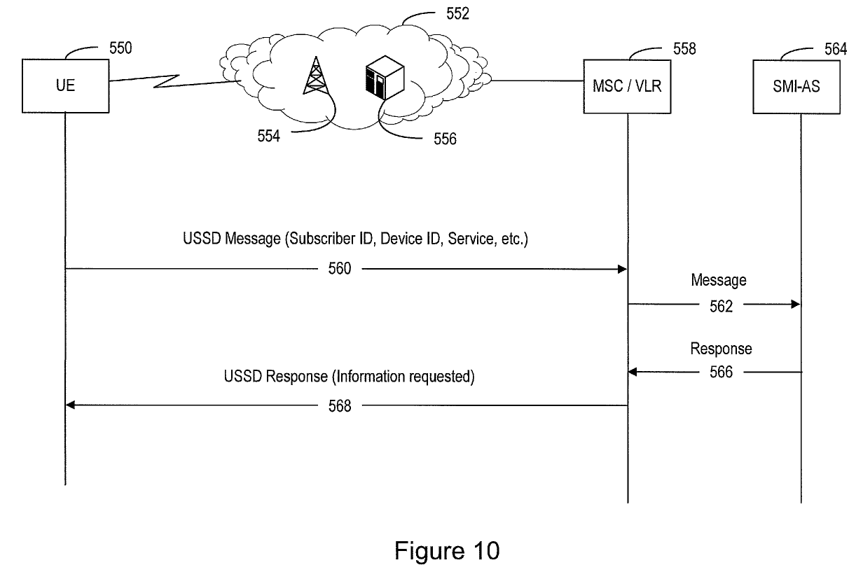

In certain embodiments, the UE device may be configured to activate, interrogate, deactivate or modify the user policy by communication with the message interworking application server (e.g., SMI-AS), as shown in FIG. 10. USSD may be employed for this function in the circuit-switched domain. XML Configured Access Protocol (“XCAP”) over the Ut interface or SIP-Publish may be employed for this function in the IMS domain.

FIG. 10 depicts a message flow diagram depicting USSD communications between a UE device 550 and a SMI-AS 564 via a wireless network. UE device 550 is operably connected to Mobile Services Switching Center/Visitor Location Register (“MSC/VLR”) 558 via wireless network 552, which includes a base station tower 554 and base station controller 556. UE device 550 transmits a USSD message 560 to MSC/VLR 558 via network 552. A user policy control message could contain, for example, a subscriber identifier such as, but not limited to, an IMSI, a terminal identifier, also known as an instance ID, such as, but not limited to, an IMEI, MAC address or ESN. A user policy control message could also contain an action to be taken and policy information. A combination identifier, such as a GRUU, could be used in place of separate subscriber and terminal identifiers. Possible actions to be taken could include, but are not limited to, “activate,” “deactivate,” “modify” and “interrogate.” Whatever the content of message 560, MSC/VLR 558 forwards the message on to SMI-AS 564 as message 562. SMI-AS 564 responds to message 562 via response 566 to MSC/VLR 558. Response 566 is forwarded to UE device 550 via network 552 as USSD response 568.

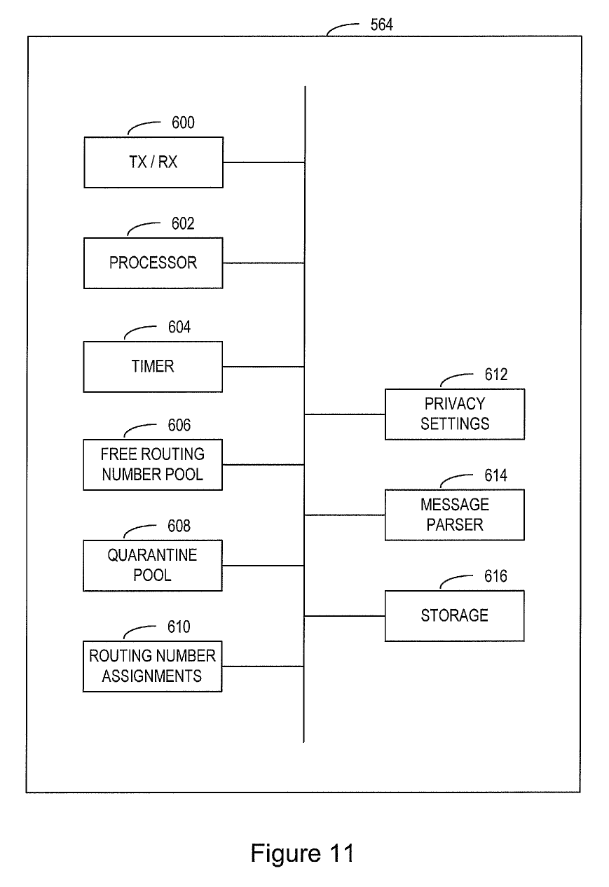

FIG. 11 depicts a block diagram of SMI-AS 564 according to certain embodiments. As seen in FIG. 11, SMI-AS 564 comprises a processor 602 operably connected to a transmit/receive (“TX/RX”) module 600, a timer module 604, a storage module 606 for unassigned routing numbers, a storage module 608 for quarantined routing numbers, a storage module 610 for data related to assigned routing numbers, a storage module 612 for subscriber privacy settings, a message parser 614 and general storage module 616. Those of skill in the art will appreciate that particular embodiments of an SMI-AS may incorporate additional or fewer components, as required by a particular application.

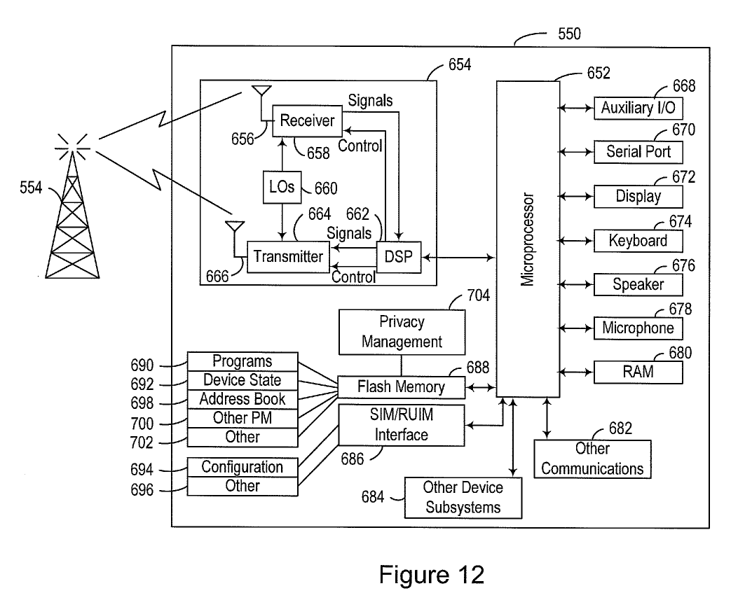

FIG. 12 depicts a block diagram of a user equipment device according to one embodiment. It will be recognized by those skilled in the art upon reference hereto that although an embodiment of user equipment device 550 may comprise an arrangement similar to one shown in FIG. 12, there can be a number of variations and modifications, in hardware, software or firmware, with respect to the various modules depicted. Accordingly, the arrangement of FIG. 12 should be taken as illustrative rather than limiting with respect to the embodiments of the present disclosure.

A microprocessor 652 providing for the overall control of an embodiment of user equipment device 550 is operably coupled to a communication subsystem 654 which includes a receiver 658 and transmitter 664 as well as associated components such as one or more local oscillator (LO) modules 660 and a processing module such as a digital signal processor 662. As will be apparent to those skilled in the field of communications, the particular design of the communication module 654 may be dependent upon the communications network with which the user equipment device 550 is intended to operate.

In one embodiment, the communication module 654 is operable with both voice and data communications. Regardless of the particular design, however, signals received by antenna 656 through base station 554 are provided to receiver 658, which may perform such common receiver functions as signal amplification, frequency down conversion, filtering, channel selection, analog-to-digital (A/D) conversion, and the like. Similarly, signals to be transmitted are processed, including modulation and encoding, for example, by digital signal processor 662, and provided to transmitter 664 for digital-to-analog (D/A) conversion, frequency up conversion, filtering, amplification and transmission over the air-radio interface via antenna 656.

Microprocessor 652 also interfaces with further device subsystems such as auxiliary input/output (“I/O”) 668, serial port 670, display 672, keyboard 674, speaker 676, microphone 678, random access memory (“RAM”) 680, a short-range communications subsystem 682, and any other device subsystems generally labeled as reference numeral 684. To control access, a Subscriber Identity Module (“SIM”) or Removable User Identity Module (“RUIM”) interface 686 is also provided in communication with the microprocessor 652.

In one implementation, SIM/RUIM interface 686 is operable with a SIM/RUIM card having a number of key configurations 694 and other information 696 such as identification and subscriber-related data. Operating system software and transport stack software may be embodied in a persistent storage module (i.e., non-volatile storage) such as flash memory 688. In one implementation, flash memory 688 may be segregated into different areas, e.g., storage area for computer programs 690 as well as data storage regions such as device state 692, address book 698, other personal information manager (“PIM”) data 700, and other data storage areas generally labeled as reference numeral 702. A privacy management module 704 is also shown disposed within flash memory 688, although those of skill in the art will appreciate that privacy management module 704 may be disposed elsewhere within user equipment device 550.

It is believed that the operation and construction of the embodiments of the present patent application will be apparent from the Detailed Description set forth above. While the exemplary embodiments shown and described may have been characterized as being preferred, it should be readily understood that various changes and modifications could be made therein without departing from the scope of the present disclosure as set forth in the following claims.

1. A method for sending an anonymous message from a first node to a second node, comprising:
receiving from the first node a first message addressed to the second node;
determining, based on privacy data, whether the first message is to be sent to the second node anonymously; and
if the first message is to be sent to the second node anonymously, generating a second message to the second node comprising at least a portion of the first message and having a sender identifier matching a temporary identifier.

2. The method as set forth in claim 1 further comprising:
associating the temporary identifier with the first node;
receiving from the second node a third message in response to the second message;
identifying a node associated with the sender identifier for the second message; and
forwarding the third message to the node associated with the sender identifier for the second message.

3. The method as set forth in claim 1 wherein the message containing privacy configuration data includes at least one of an activation instruction, a deactivation instruction, a modify instruction and an interrogate instruction.

4. The method as set forth in claim 1 wherein the message containing privacy configuration data includes a uniform resource identifier (URI).

5. The method as set forth in claim 4 wherein the uniform resource identifier is a Session Initiation Protocol (SIP) URI.

6. The method as set forth in claim 4 wherein the uniform resource identifier is a Telephone network (Tel) URI.

7. The method as set forth in claim 1 wherein the first node and the second node employ incompatible messaging protocols.

8. The method as set forth in claim 1 wherein the temporary identifier is retrieved from a database.

9. An application server configured to send an anonymous message from a first node to a second node, comprising:
a component configured to receive from the first node a request to conceal the identity of the first node;
a component configured to receive from the first node a first message addressed to the second node;
a component configured to determine, based on the request to conceal, whether the first message is to be sent to the second node anonymously; and
a component configured to generate a second message to the second node comprising at least a portion of the first message and having a sender identifier matching a temporary identifier if the first message is to be sent to the second node anonymously.

10. The application server as set forth in claim 9 further comprising:
a component configured to associate the temporary identifier with the first node;
a component configured to receive from the second node a third message in response to the second message;
a component configured to identify a node associated with the sender identifier for the second message; and
a component configured to forward the third message to the node associated with the sender identifier for the second message.

11. The application server as set forth in claim 9 wherein the message containing privacy configuration data includes at least one of an activation instruction, a deactivation instruction, a modify instruction and an interrogate instruction.

12. The application server as set forth in claim 9 wherein the message containing privacy configuration data includes a uniform resource identifier (URI).

13. The application server as set forth in claim 12 wherein the uniform resource identifier is a Session Initiation Protocol (SIP) URI.

14. The application server as set forth in claim 12 wherein the uniform resource identifier is a Telephone network (Tel) URI.

15. The application server as set forth in claim 9 wherein the first node and the second node employ incompatible messaging protocols.

16. The application server as set forth in claim 9 wherein the temporary identifier is retrieved from a database.

17. A user equipment device operable to configure a remote node for anonymous messaging, comprising:
a component configured to receive from a user privacy configuration data for outgoing messages from the user equipment device to external nodes;
a component configured to store the privacy configuration data for outgoing messages; and
a component configured to transmit to a remote application server a message containing the privacy configuration data for outgoing messages, wherein the configuration data is operable to instruct the application server to remove at least one identifier for the user equipment device from at least one outgoing message.

18. The user equipment device as recited in claim 17, further comprising a component configured to receive settings data from the application server.

19. The user equipment device as recited in claim 17, wherein the configuration data includes a uniform resource identifier (URI).

20. The user equipment device as recited in claim 19, wherein the URI is a SIP URI.

21. The user equipment device as recited in claim 19, wherein the URI is a Tel.URI.

22. The user equipment device as recited in claim 17, wherein the message to the application server contains at least one of an activate instruction, a deactivate instruction, a modify instruction or an interrogate instruction.

23. A method for sending an anonymous message from a first node to a second node, comprising:
receiving from the first node a first message addressed to the second node in a first messaging system, the message including data identifying the first node;
determining, based on a privacy tag setting in the first message, whether anonymous messaging is to be invoked;
if anonymous messaging is to be invoked, substituting the data identifying the first node with a temporary identifier; and
sending a second message to the second node using a second messaging system whereby the originating users identity cannot be derived by inspection.
